(19) United States
(12) Patent Application Publication
(10) Pub. No.: US 2005/0058751 A1
(43) Pub. Date: Mar. 17, 2005

(54) Yield and shelf life for meats

(76) Inventors: Eugene Brotsky, Elizabeth, NJ (US); David Charest, Olathe, KS (US); Heinz Keller, Neukirch-Egnach (CH)

Correspondence Address: Scott A. McCollister, Esq.;Fay, Sharpe, Fagan, Minnich & McKee, LLP, Seventh Floor, 1100 Superior Avenue, Cleveland, OH, 44114-2518, US

(21) Appl. No.: 10/894,899

(22) Filed: Jul. 20, 2004

Related U.S. Application Data
(60) Provisional application No. 60/488,898, filed on Jul. 21, 2003.

(51) Int. Cl. C12H 1/10

(52) U.S. Cl. 426/321

(57) ABSTRACT

The invention is directed to a process for treating meat to achieve higher yield, without negatively affecting the appearance of the meat. The process comprises the steps of 1) treating the meat, preferably by injection, with a higher pH phosphate solution having a pH of above pH 6.0 and 2) after treating the meat with the higher pH phosphate solution, contacting the meat, preferably by dipping or spraying, with a lower pH solution of preferably less than about pH 5.6.

This application claims the benefit of U.S. Provisional Application No. 60/488,898, filed Jul. 21, 2003.

### FIELD OF THE INVENTION

This invention relates generally to an improved process for treating and packaging fresh meat, and more particularly, to methods for chemically treating meat and packaging or storing meat so that the meat remains in an unspoiled, fresh appearing condition over an extended period of time.

### BACKGROUND OF THE INVENTION

The treatment and packaging of fresh meat has been a subject of research and development for several years. Fresh meat, during and after slaughter, may contain or become contaminated with certain undesirable bacteria such as salmonella, campylobacter, listeria, spoilage bacteria, and the like. Meat is generally processed by removing the hide or feathers, eviscerating, cooling, and then treating the meat to minimize undesirable bacteria and to maintain the meat in an unspoiled, fresh appearing condition.

A variety of fresh meat treatment chemicals, packaging atmospheres and packaging materials are known. Treatment chemicals have included sugar, salts, curing compounds, organic acids, isoascorbate, and the like. Packaging atmospheres generally contain varying proportions of inert gases such as carbon dioxide, nitrogen, red pigment forming gases (such as oxygen and carbon monoxide), and other gases. Many of these packaging atmospheres have been studied in conjunction with various treatment systems.

Myoglobin, hemoglobin and other like compounds found in meat are believed to be responsible for the red and red-purple color of fresh meat. Upon exposure to air these compounds are oxidized to form oxymyoglobin and oxyhemoglobin which are bright red in color. Exposure to air over prolonged periods results in further oxidation and the formation of metmyoglobin and methemoglobin, which are brown or grey in color and which detract from the appearance and sale-ability of the meat.

U.S. Pat. No. 3,154,421 discloses that the desirable bright red fresh meat color can be maintained for about a one week period in the case of fresh meat packaged in air (about 21 percent O₂) by treating the meat with a mixture of phosphate salts, ascorbic acid, or alkali metal salts, and a sequestering agent, such as citric acid.

A second patent to Zyss, U.S. Pat. No. 3,775,543, suggests the addition of phosphate compositions including potassium orthophosphates to processed meats as a binding agent in from 0.2 to 2.0% by weight of the mix. Zyss avoids alkaline pH as he indicated that alkaline pH decreases the meat's shelf life. Zyss neutralizes with acid to pH 6.4 to 6.8.

Cheng, U.S. Pat. No. 4,683,139, teaches a process for prepackaged fresh meat at retail wherein the shelf life of the meat is increased by treatment with an aqueous solution of an alkali metal salt of certain phosphate compounds, a reducing compound such as ascorbic acid and a sequestering or chelating agent such as citric acid. The phosphate can be an orthophosphate, pyrophosphates, tripolyphosphates and hexametaphosphates. The meat pH is below neutral.

Ruzek, U.S. Pat. Nos. 5,976,593 and 5,985,342 teach a process for packaging fresh pork wherein the fresh pork package has enhanced visual appeal and shelf life stability, by introducing into the pork a treatment solution comprising a lactate buffer salt, a phosphate sequestrant and a diacetate microbial growth inhibitor, and packaging the pork in a display unit. The display unit can comprise a thermoplastic tray covered by a transparent film, and the display unit can be packaged in a film wrapped container. The atmosphere within the container can be maintained as a high oxygen atmosphere.

Another patent to Ruzek, U.S. Pat. No. 5,989,610, discloses the same process as described above and further discloses that the display unit can also comprise a dividable portion of meat enclosed in a barrier bag.

Yet another patent to Ruzek, U.S. Pat. No. 5,780,085 discloses a similar treatment solution as described above, however the diacetate is a flavor enhancement agent.

Kohl, et al., U.S. Pat. No. 3,681,091, teaches treating foods including fish fillet with 10% solutions of medium chain length polyphosphates.

Many treatment systems for poultry have been suggested. It has been reported that the thermal death rate of salmonellae can be increased during scalding by elevating the pH of the scald water to pH 9.0+/−0.2. Agents such as sodium hydroxide, potassium hydroxide, sodium carbonate, and trisodium phosphate have been reported as effective pH adjusting agents for use in increasing the thermal death rate of the bacteria. Trisodium phosphate was reported as least effective in increasing the death rate. See “The Effect on pH Adjustment on the Microbiology of Chicken Scald-tank Water with Particular Reference to the Death Rate of Salmonellae”, T. J. Humphrey, et al., Journal of Applied Bacteriology 1981, 51, pp. 517-527.

Attempts have made to pasteurize poultry meat by treating the meat with a solution containing agents such as lactic acid, acetic acid, sodium carbonate, sodium borate, sodium chloride, potassium hydroxide, chlorine and ethylene diamine tetracetic acid (EDTA). All treatments, except sodium borate, sodium chloride, and sodium carbonate, reduced the visual acceptability of the meat. Chlorine failed to destroy bacteria on the surface of the poultry but would be expected to control salmonellae in water. See Chemical Pasteurization of Poultry Meat, J. S. Teotia, Dissertation Abstracts Int'l. B., 1974, 34(a), 4142.

It is known that the shelf life of chicken carcasses can be increased 1 to 2 days by chilling the poultry in a solution of 6% sodium tripolyphosphate/0.7% tetrasodium pyrophosphate (Kena—available from Rhone-Poulenc, Inc., Food Ingredients Division). See The Antimicrobial Effect of Phosphate With Particular Reference To Food Products”, L. L. Hargreaves, et al., The British Food Manufacturing Industries Research Association, Scientific and Technical Surveys, No. 76, April 1972, Pages 1-20 at Page 12. Accordingly, many patents and articles suggest the use of polyphosphates in preserving meat and fish products.

In red meat, for example, after the meat is processed by removing the hide or feathers, eviscerating, and cooling, the meat is cut into larger cuts for processing into cured or uncured (fresh meat). Cured meats are typically injected with a solution of polyphosphate, salt, and sodium nitrite. Fresh meat processed as enhanced case-ready meat is typically injected with a solution of polyphosphate and salt.

“Case-ready meat” is a term which generally refers to meat which is prepared and packaged at a meat processing plant such that it is ready for immediate retail display and sale upon arrival at a store, where an optional barrier film layer may be removed to allow the red meat to “bloom” to a desired bright red color. Case ready-meats are typically sold either vacuum packaged, in which the plastic packaging fits snugly around the meat, or in a modified atmosphere or “gas flushed” packaging wherein various combinations of gases, such as oxygen, nitrogen and/or carbon dioxide are flushed into the package. For example, when beef is vacuum-packaged, oxygen is removed causing the beef to appear in its natural purple color. Vacuum packaging has many advantages, like eliminating freezer burn and allowing a shelf-life three to five times longer than conventional packaging methods. However, the purple color of vacuum-packaged beef is not ideal because consumers associate bright red meat with freshness. While vacuum packaging is still used for many products, “gas flush packaging” is also commonly used. Gas flush packaging uses oxygen in combination with carbon dioxide and/or nitrogen, which causes beef products to become the desired bright red color preferred by consumers.

An “Enhanced” case-ready meat refers to products wherein marinades or special processing “enhances” the meat. In some cases, these enhanced meats are raw and need to be cooked thoroughly. In other cases, stores are providing partially cooked or fully cooked heat-and-eat products, like pre-cooked roasts that need only be microwaved. As explained above, enhanced case-ready meats are typically injected with a water, phosphate, and salt solution or marinade. The marinade generally improves flavor and sometimes yield, but can adversely affect meat appearance.

Alkaline phosphates are generally used in the marinade to achieve higher yield and avoid storage losses, however the higher pH of alkaline phosphate marinades causes adverse darkening during extended storage of meats, particularly beef. Lowering the pH avoids darkening but decreases yield.

Accordingly, there exists a need in the art for an improved process for treating meat that achieves high yield and good appearance in meats, particularly case-ready meats, throughout the shelf life.

### SUMMARY OF THE INVENTION

The present invention is directed to a process for treating meat to achieve higher yield, without negatively affecting the appearance of the meat. The process comprises the steps of 1) treating the meat, preferably by injection, with a phosphate solution having a higher pH of preferably above pH 6.0; and 2) after treating the meat with the higher pH phosphate solution, contacting the meat, preferably by dipping or spraying the meat, with a lower pH acidic solution of preferably less than about pH 5.6, to achieve a lower surface pH and avoid a darkening of the muscle tissue resulting from higher pH. By contacting the meat with a lower pH acidic solution after treating the meat with a higher pH phosphate solution, the pH of the meat surface is lower than the pH of the meat surface after treatment with the higher pH phosphate solution.

The process of the invention is preferably conducted after slaughter prior to or after chilling and prior to packaging of the meat.

Specifically, it has been discovered that meat, including pork, beef, veal, mutton, poultry, fish, game, ratite, and goat, can be treated by contacting the meat with a concentration of from about 7% to about 15% of a higher pH phosphate solution, and subsequently contacting the meat with a lower pH acidic solution having a concentration of from about 0.1% to about 10% acidic active ingredient.

### DETAILED DESCRIPTION OF INVENTION AND PREFERRED EMBODIMENTS

It has been discovered, in accordance with the invention, that treating meat by contacting the meat with a higher pH phosphate solution, then contacting the meat with a lower pH phosphate solution provides high yield and improved appearance through-out the shelf-life of the meat in comparison to conventional meat enhancement methods.

In an embodiment of the invention, the meat is treated with a higher pH phosphate solution. The higher pH phosphate solution generally has a pH of at least about 6.0, and preferably within a range of from about 7 to about 10. The higher pH phosphate solution preferably comprises a phosphate active ingredient, water, and salt. The composition of the higher pH solution is generally from about 1% to about 10% phosphate active ingredient, from about 70% to about 95% water, and from about 1% to about 5% salt. A more preferable higher pH solution may comprise about 3% to about 5% phosphate active ingredient, about 2% to about 3% salt, and about 89% to about 93% water. The phosphate active ingredient is preferably an alkaline phosphate. Preferred alkaline phosphates include tetrasodiumpyrophoshate (TSPP), tetrapotassium pyrophosphate (TKPP), sodium tripolyphosphate (STPP), or combinations thereof. The phosphate active ingredient may also include combinations of non-alkaline phosphates, for example, sodium hexametaphosphate (SHMP), sodium acid pyrophosphate (SAPP) or trisodium pyrophosphate (3SP), with one or more other the preferred alkaline phosphates described above. For example, a suitable alkaline phosphate combination may include the following blends:
STPP and SHMP
STPP and SAPP
SAPP and TKPP
TSPP and TKPP
   Any suitable salt may be used, however sodium chloride (NaCl) is preferably used.

Optionally, a pH or alkalinity increasing agent may also be added to the higher pH solution. Suitable alkalinity increasing agents include sodium hydroxide (NaOH), trisodiumphosphate (TSP), sodium metasilicate (SMS), and potassium hydroxide (KaOH). The alkalinity increasing agent helps to reduce the microbial load in the higher pH solution and further prevents undesirable microbes from being injected into the meat.

The meat may be treated or contacted with the higher pH solution by any suitable manner, including tumble or massage marinating or direct injection, with injection being preferred. The higher pH solution is preferably applied to the meat by injection, because the injected phosphate contacts the protein more uniformly than other methods thereby resulting in improved yield and consistency. No matter which process is used, from about 3% to about 15% phosphate active ingredient concentration in the solution is preferred in order to achieve from about 0.2% to about 0.7% phosphate concentration in the meat, and more preferably about 0.3% to about 0.5% phosphate concentration in the meat.

After the meat is treated with the higher pH solution, the meat is then treated with a lower pH acidic solution. The lower pH acidic solution (hereinafter “acidic solution”) generally has a pH of less than about 5.6 and is preferably less than about 4.8. The acidic solution preferably comprises a lower pH active ingredient, water, and optionally an antimicrobial agent. The composition of the acidic solution is generally from about 1% to about 10% lower pH active ingredient, from about 30% to about 99% water, and from about 0% to about 60% antimicrobial agent. A more preferred higher pH solution may comprise about 5% lower pH active ingredient, optionally about 15% to about 40% antimicrobial agent, with the remainder of the solution being water. Any suitable lower pH active ingredient or combinations of such may be used. Preferred lower pH active ingredients include citric acid and more preferably lower pH phosphates. A preferred lower pH active ingredient includes sodium acid pyrophosphate (SAPP).

Any suitable antimicrobial agent or combination of antimicrobial agents may be used. Preferably the antimicrobial agent will include a metabolite material of propionibacteria, having a metabolite of molecular weight greater than 300 to inhibit the growth of gram negative psychotropic bacteria, yeast, mold, gram positive bacteria, or Listeria. One such suitable anti-microbial agent comprising a metabolite-containing material that is produced by a culture of Propionibacterium and that contains a metabolite, other than propionic acid, wherein the material is present in an amount sufficient to provide for the metabolite inhibiting the growth of gram negative psychotropic bacteria is described in U.S. Pat. No. 5,096,718 to Ayres, which is herein incorporated by reference. Other suitable antimicrobial agents include those described in U.S. Pat. Nos. 5,387,427; 5,096,718; 5,260,061; 5,635,484; 5,989,612; 6,207,210; 6,287,617; 6,451,365; 6,475,537; and 5,286,506, which are all assigned to Rhodia Inc. and incorporated by reference herein. Accordingly, suitable antimicrobial agents include Microgard® 200/250 (commercially available from Rhodia Inc.), diacetate, or combinations of diacetate and Microgard®.

Preferred lower pH acidic solution compositions include the following:
5% SAPP and 95% water
5% SAPP; 25% Microgard®; and 70% water
5% SAPP; 10% diacetate; and 85% water
5% SAPP; 25% Microgard®; 10% diacetate; and 60% water

The meat may be contacted with the acidic solution either by tumbling, dipping, or spraying. Dipping or spraying of the acidic solution may be preferred in cases where it is more efficient time wise to do so. In any case, any suitable contacting mechanism by which rapid contacting is employed is more preferred. The meat should be contacted with the acidic solution for a period of time sufficient to coat the surface of the meat i.e., such that the acidic solution may contact all contactable exposed surfaces of the meat. At atmospheric pressure, in a dip tank, dwell times from about 5 seconds to about 30 minutes are effective, with a dipping time of about 1 minute or less being preferred. Dwell times using a spray may range from about several seconds to about several minutes or about 2 seconds to about 15 minutes with spray times of less than 30 seconds being preferred. Dwell times using tumbling may range from about 30 seconds to several hours, with a dwell time of about less than 5 minutes being preferred.

It should also be appreciated that the compositions of the solutions used in the process of the invention may be varied according to the desired characteristics of the meat. The following non-limiting examples will further illustrate the preparation and performance of the preferred compositions in accordance with the invention. However, it is to be understood that these examples are given by way of illustration only and are not a limitation of the invention.

### EXAMPLE

A higher pH phosphate solution was prepared by dispersing dry pre-blended phosphate into cold water and stirring with a mixer until the phosphates were dissolved completely. The higher pH solution used in the example had a composition of 93.5% water, 2.8% NaCl, and 3.7% phosphates. The pH of the control was about 9.5. Fresh beef strip loins having similar size and weight were used.

The temperature of the beef strip loins was maintained at about 36° F. The beef strip loins were injected up to about 10% extension with the higher pH solutions. The beef strip loins were then cut into 1 inch steaks. A control, Steak 1, was set aside, while Steaks 2A and 3A were dipped in acidic solution for about 30 seconds, and Steaks 2B and 3B were surface sprayed with acidic solutions to saturate the surface. The acidic solution used to treat steaks 2A and 2B included about 5% SAPP and 95% water. The acidic solution used to treat steaks 3A and 3B included about 25% Microgard® 250, 5% SAPP, and about 70% water.

The steaks were then weighed after draining for 30 seconds. The steaks were placed on trays lined with soak pads and into gas impermeable bags. The gas impermeable bags were closed using a modified atmosphere of about 80% oxygen (O₂) and about 20% carbon dioxide (CO₂). The steaks were then stored at about 35° F. for the first 10 days without light, and then from day 11 on, with exposure to light.

Surface pH of the Meat

| | fresh meat | after injection | after dip/spray |
|---|---|---|---|
| Control | 5.89 | 6.07 | n/a |
| Steak 2A | 5.89 | 6.14 | 5.87 |
| Steak 2B | 5.82 | 5.99 | 5.75 |
| Steak 3A | 5.96 | 6.25 | 6.14 |
| Steak 3B | 5.95 | 6.19 | 5.86 |

All of the steaks exhibited higher pH values after injection. The Acid dip lowered the pH values and in some instances lowered the pH to a value lower than the steaks' pH prior to injection.

Yield was also measured for the control (“C”) and the dipped steaks 2A and 3A. The results were as follows:

| | | | Sliced | | | | | |
|---|---|---|---|---|---|---|---|---|
| | Target | | Pre- | After | | Cooked | | Cooking |
| | Injection | Strip Loin* | storage | Storage | STDV | Yield* | STDV | Loss |
| C | 112 | 112.3 | 110.6 | 105.0 | 1.4 | 76.9 | 3.2 | 26.4 |
| 2A | 110 | 112.9 | 112.8 | 106.6 | 1.0 | 78.7 | 2.2 | 26.1 |
| 3A | 110 | 111.9 | 111.7 | 105.5 | 1.3 | 80.2 | 4.0 | 24.3 |

*Strip Loin was measured after injected and dipped; Cooked yield was measured relative to the fresh weight.

It can be seen that the 30 second dip had a positive effect on yield both after slicing and after cooking.

Color was measured for the control and the treated steaks. The color was ranked on a score of 1 through 9 with 9 being best, meaning that the steaks exhibited an intense red that was not too dark and acceptable to consumers.

APPEARANCE

| | Day | | | | | | |
|---|---|---|---|---|---|---|---|
| | 1 | 8 | 11 | 12 | 13 | 15 | 18 |
| Control | 9 | 8 | 7 | 7 | 5 | 5 | 5 |
| 2A | 9 | 7 | 7 | 5 | 8 | 7 | 8 |
| 2B | 9 | 7 | 7 | | 7 | 9 | |
| 3A | 9 | 7 | 8 | 8 | 7 | 7 | 8 |
| 3B | 9 | 7 | 7 | | 7 | 8 | |

It can be seen that the acidic treatments helped to maintain color.

Microbiology tests were also performed. The aerobic standard plate count (SPC) was measured for the control and the treated steaks at days 1, 11, 14 and 18.

Microbiology

| | Day | | | |
|---|---|---|---|---|
| | 1 | 11 | 14 | 18 |
| Control | 1,700 | 18,500 | 5,600,000 | 47,500,000 |
| 2A (dip) | 470 | 48,500 | 2,250,000 | 2,700,000 |
| 3A (MG + dip) | 835 | 880 | 6,000 | 46,000 |
| 2B (spray) | 825 | 13,250 | 1,385,000 | 88,000,000 |
| 3B (MG + spray) | 295 | 15,250 | 3,000 | 400,000 |

The steaks treated with Microgard exhibited better control of spoilage and remained edible for up to about 15 days.

1. A process for treating meat comprising treating the meat with a first solution having a pH above 6.0 and after treating the meat with said first solution, treating the meat with a second solution having a pH of less than about 5.6.

2. The process of claim 1 wherein said step of treating the meat with said second solution comprises treating the meat in an amount of said second solution and for a period of time effective to lower the surface pH of the meat.

3. The process of claim 1 wherein said step of treating the meat with said second solution comprises treating the meat in an amount of said second solution and for a period of time effective to maintain the meat appearance from treatment throughout a shelf-life of the meat.

4. The process of claim 3 wherein said shelf life is at least 8 days.

5. The process of claim 4 wherein said shelf-life is from about 8 to about 20 days.

6. The process of claim 1 wherein said step of treating the meat with said second solution comprises treating the meat in an amount of said second solution and for a period of time effective to increase yield from the meat.

7. The process of claim 1 wherein said first solution comprises a phosphate active ingredient.

8. The process of claim 7 wherein said phosphate active ingredient is an alkaline phosphate.

9. The process of claim 7 wherein said alkaline phosphate comprises tetrasodiumpyrophoshate (TSPP), tetrapotassium pyrophosphate (TKPP), or sodium tripolyphosphate (STPP).

10. The process of claim 7 wherein said phosphate active ingredient comprises a combination of alkaline phosphate and non-alkaline phosphate.

11. The process of claim 7 wherein said non-alkaline phosphate comprises sodium acid pyrophosphate (SAPP), sodium hexametaphosphate (SHMP), or trisodium pyrophosphate (3SP).

12. The process of claim 7 wherein said first solution comprises from about 1% to about 10% phosphate active ingredient.

13. The process of claim 12 wherein said first solution comprises from about 70% to about 95% water.

14. The process of claim 12 wherein said first solution comprises from about 1% to about 5% salt.

15. The process of claim 12 wherein said first solution comprises from about 3% to about 5% phosphate active ingredient.

16. The process of claim 15 wherein said first solution comprises from about 89% to about 93% water.

17. The process of claim 15 wherein said first solution comprises from about 2% to about 3% salt.

18. The process of claim 1 wherein said first solution further comprises an alkalinity increasing agent.

19. The process of claim 18 wherein said alkalinity increasing agent comprises sodium hydroxide (NaOH), trisodiumphosphate (TSP), sodium metasilicate (SMS), or potassium hydroxide (KaOH).

20. The process of claim 1 wherein treating said meat with said first solution comprises injecting said meat with said first solution.

21. The process of claim 1 wherein treating said meat with said first solution comprises tumbling said meat to contact said meat with said first solution.

22. The process of claim 1 wherein treating said meat with said second solution comprises dipping said meat in said second solution.

23. The process of claim 1 wherein treating said meat with said second solution comprises spraying said meat with said second solution.

24. The process of claim 1 wherein treating said meat with said second solution comprises tumbling said meat to contact said meat with said second solution.

25. The process of claim 1 wherein said step of treating the meat with said first solution comprises treating the meat with a concentration of from about 3% to about 15% of an active ingredient of said first solution.

26. The process of claim 7 wherein said step of treating the meat with said first solution comprises treating the meat in an amount of said first solution effective to achieve from about 0.2% to about 0.7% phosphate active ingredient concentration in said meat.

27. The process of claim 26 wherein said step of treating the meat with said first solution comprises treating the meat in an amount of said first solution effective to achieve from about 0.3% to about 0.5% phosphate active ingredient concentration in said meat.

28. The process of claim 1 wherein said second solution comprises an acidic active ingredient.

29. The process of claim 28 wherein said acidic active ingredient comprises citric acid.

30. The process of claim 28 wherein said acidic active ingredient comprises phosphate.

31. The process of claim 28 wherein said acidic active ingredient comprises SAPP.

32. The process of claim 1 wherein said second solution comprises an antimicrobial agent.

33. The process of claim 32 wherein said antimicrobial agent comprises a metabolite-containing material that is produced by a culture of Propionibacterium and that contains a metabolite, other than propionic acid, wherein the material is present in an amount sufficient to provide for the metabolite inhibiting the growth of gram negative psychotropic bacteria.

34. The process of claim 32 wherein said antimicrobial agent comprises a metabolite material of propionibacteria, having a metabolite of molecular weight greater than 300 sufficient to inhibit growth of gram negative psychotropic bacteria, yeast, mold, gram positive bacteria, or Listeria.

35. The process of claim 1 wherein said second solution comprises diacetate.

36. The process of claim 1 wherein said step of treating the meat with said second solution comprises treating the meat in an amount of said second solution and for a period of time effective to cover the surface of the meat.

37. The process of claim 36 wherein said step of treating the meat with said second solution comprises dipping the meat for a period of about 5 to about 30 seconds.

38. The process of claim 37 wherein said step of treating the meat with said second solution comprises dipping the meat for a period of about 1 minute or less.

39. The process of claim 36 wherein said step of treating the meat with said second solution comprises spraying the meat from about 2 seconds to about 15 minute.

40. The process of claim 39 wherein said step of treating the meat with said second solution comprises spraying the meat for less than about 30 seconds.

41. The process of claim 36 wherein said step of treating the meat with said second solution comprises tumbling the meat from about 30 seconds to about several hours.

42. The process of claim 41 wherein said step of treating the meat with said second solution comprises tumbling the meat for less than about 5 minutes.

43. The process of claim 28 wherein said second solution comprises from about 1% to about 10% acidic active ingredient.

44. The process of claim 43 wherein said second solution comprises from about 30% to about 99% water.

45. The process of claim 43 wherein said second solution comprises from about 0% to about 60% antimicrobial agent.

46. The process of claim 43 wherein said second solution comprises from about 5% acidic active ingredient.

47. The process of claim 46 wherein said second solution comprises from about 45% to about 80% water.

48. The process of claim 46 wherein said second solution comprises from about 15% to about 40% antimicrobial agent.

49. A process for treating case-ready meat comprising the steps of: injecting the meat with a higher pH phosphate solution and, after injecting the meat, treating the surface of the meat with an acidic solution.

50. The process of claim 49 wherein said step of treating the surface of the meat comprises contacting the meat with an amount of said acidic solution and for a period of time effective to cover the surface of the meat.

51. The process of claim 49 wherein said step of treating the surface of the meat comprises treating the meat with an amount of said acidic solution and for a period of time effective to lower the surface pH of the injected meat.

52. The process of claim 49 wherein said step of treating the surface of the meat comprises contacting the meat with an amount of said second solution and for a period of time effective to increase yield from the meat.

53. The process of claim 49 wherein said step of treating the surface of the meat comprises treating the meat with an amount of said acidic solution and for a period of time effective to maintain the meat appearance throughout a shelf-life of the meat.

54. The process of claim 53 wherein said shelf life is at least 8 days.

55. The process of claim 54 wherein said shelf-life is from about 8 to 20 days.

56 The process of claim 49 wherein said step of treating the surface of said meat comprises dipping said meat in said acidic solution.

57. The process of claim 49 wherein said step of treating the surface of said meat comprises spraying said meat with said acidic solution.

58. The process of claim 49 wherein said step of treating the surface of said meat comprises tumbling said meat to contact said meat with said acidic solution.

59. The process of claim 49 wherein said step of injecting said meat comprises injecting said meat with said higher pH phosphate solution, said higher pH phosphate solution having from about 3% to about 15% concentration of a higher pH active ingredient.

60. The process of claim 49 wherein said higher pH phosphate solution comprises a phosphate active ingredient having a pH of greater than about 6.

61. The process of claim 49 wherein said acidic solution comprises an active ingredient having a pH of less than about 5.6.

62. A product produced by the method of claim 1.

63. A product produced by the method of claim 49.

64. A process for improving yield and maintaining the appearance of beef through-out the shelf-life of the beef comprising the steps of:
(a) preparing a higher pH solution;
(b) injecting said higher pH solution into beef;
(c) after injecting said beef, coating said beef with a lower pH solution;
(d) packaging said beef; and
(e) storing said beef.

65. The process of claim 64 wherein preparing said higher pH solution comprises mixing a higher pH active ingredient, salt, and optionally water.

66. The process of claim 64 wherein said higher pH solution comprises about 93% water, 3% sodium chloride, and 4% phosphate active ingredient.

67. The process of claim 65 wherein said higher pH solution has a concentration of from about 3% to about 15% of said higher pH active ingredient.

68. The process of claim 65 wherein injecting said beef with said higher pH solution is effective to achieve from about 0.2% to about 0.7% higher pH active ingredient into said beef.

69. The process of claim 68 wherein injecting said beef with said higher pH solution is effective to achieve from about 0.3% to about 0.5% higher pH active ingredient into said beef.

70. The process of claim 64 further comprising the step of cutting the beef after injecting the beef with said higher pH solution and before coating the beef with said lower pH solution.

71. The process of claim 64 wherein coating said beef with said lower pH solution comprises dipping said beef in said lower pH solution.

72. The process of claim 71 comprising dipping the beef for a period of about 5 to about 30 seconds.

73. The process of claim 71 comprising dipping the beef for a period of about 1 minute or less.

74. The process of claim 64 wherein coating said beef with said lower pH solution comprises spraying said beef with said lower pH solution.

75. The process of claim 74 comprising spraying the beef from about 2 seconds to about 15 minute.

76. The process of claim 75 comprising spraying the beef for less than about 30 seconds.

77. The process of claim 64 wherein said step of coating said beef comprises contacting the beef with an amount of said lower pH solution and for a period of time effective to cover the surface of the beef.

78. The process of claim 64 wherein said step of coating said beef comprises contacting the beef with an amount of said lower pH solution and for a period of time effective to lower the surface pH of the beef.

79. The process of claim 64 wherein said lower pH solution comprises about 95% water and about 5% SAPP.

80. The process of claim 64 wherein said lower pH solution comprises about 70% water, 5% SAPP, and 25% anti-microbial agent.

81. The process of claim 64 wherein said lower pH solution comprises a metabolite-containing material that is produced by a culture of propionibacterium and that contains a metabolite, other than propionic acid, wherein the material is present in an amount sufficient to provide for the metabolite inhibiting the growth of gram negative psychotropic bacteria.

82. The process of claim 64 wherein said lower pH solution comprises an antimicrobial agent having a metabolite material of propionibacteria, said material having a metabolite of molecular weight greater than 300 and said material capable of inhibiting the growth of gram negative psychotropic bacteria, yeast, mold, gram positive bacteria, or Listeria
